(19) United States
(12) Patent Application Publication
(10) Pub. No.: US 2007/0094140 A1
(43) Pub. Date: Apr. 26, 2007

(54) System for direct presentment of cash letters

(76) Inventors: Shaun P. Riney, Oklahoma City, OK (US); Justin Hewlett, Cleburne, TX (US)

Correspondence Address: DUNLAP, CODDING & ROGERS P.C., PO BOX 16370, OKLAHOMA CITY, OK, 73113, US

(21) Appl. No.: 11/586,387

(22) Filed: Oct. 25, 2006

Related U.S. Application Data
(60) Provisional application No. 60/730,118, filed on Oct. 25, 2005.

(51) Int. Cl. G06Q 40/00

(52) U.S. Cl. 705/45

(57) ABSTRACT

A system is provided for the direct presentment of cash letters having images of cash items from a sending institution computer to a receiving institution computer. The computerized host system has a web-server communicating with at least one sending institution computer. The computerized host system receives from the at least one sending institution computer at least one cash letter. Then, the computerized host system stores the at least one cash letter and provides images of cash items in the at least one cash letter to at least one receiving institution.

### CROSS-REFERENCE TO RELATED APPLICATIONS

This Application claims the benefit under 37 C.F.R. 119(e) to U.S. Provisional application No. 60/730,118, entitled SYSTEM FOR DIRECT PRESENTMENT OF CASH LETTER, which was filed on Oct. 25, 2006, the entire contents of which are hereby incorporated by reference in their entirety as if set forth explicitly herein.

### STATEMENT REGARDING FEDERALLY SPONSORED RESEARCH AND DEVELOPMENT

Not Applicable.

### BACKGROUND OF THE INVENTION

A check is a written order to a financial institution, such as a bank to pay an amount specified from funds on deposit to a designated payee, or their authorized agent. Financial institutions that receive checks can exchange checks directly with other financial institutions, or can present checks to the Federal Reserve System or private clearinghouses for regional and national check collection. During the check clearing process, checks pass through large sorting equipment that read the magnetic ink characters (MICR) at the bottom of the check and places the check in sorting “pockets”. The MICR standard, developed in the US by a consensus group of banks and technology in the 1950s, provided tremendous improvements to the check payment process by enabling the automation of many check handling procedures. The MICR contains information such as the routing number identifying the drawee bank, the payment amount, and the customer account number of the payor. The payee's bank is then credited for the payment amount, and it transfers these funds to the payee's account. The check is then physically transported to the drawee's bank by car, truck, or airplane, and presented to the drawee's bank by the clearing institution where the payment amount is debited from the payor's bank associated with the customer account number. The payor then receives the canceled physical check or an image thereof from the bank in the next statement.

Currently, financial institutions use direct presentment of cash letters with attached cash items, such as checks, to avoid paying costly per item fees for clearing their cash items through the Federal Reserve or their correspondent bank. Prior to the present invention discussed below, banks either exchanged physical items directly or used a clearinghouse, such as the fed, to break up and distribute one image file to multiple foreign banks. Exchanging images of the cash items facilitates the exchange of cash items but at a per item cost which makes it more costly for a financial institution to do image exchange than to do a direct presentment of the physical items.

There is a need for exchanging cash items which reduces the expenses associated with direct presentment of the physical cash items. It is to this type of system that the present invention is directed.

### BRIEF SUMMARY OF THE INVENTION

In one preferred embodiment, the present invention relates to a computerized system for the direct presentment of cash letters having images of cash items from a sending institution computer to a receiving institution computer. In general, the computerized system comprises a computerized host system having a web-server communicating with at least one sending institution computer. The computerized host system receives from the at least one sending institution computer at least one cash letter. The computerized host system stores the at least one cash letter and provides images of cash items in the at least one cash letter to at least one receiving institution.

In another embodiment, the present invention relates to a method of using a computerized host system for the direct presentment of cash letters having images of cash items from a sending institution computer to a receiving institution computer. In general, the computerized host system communicates with at least one sending institution computer via a web-server. The computerized host system receives at least one cash letter from the at least one sending institution. The computerized host system stores the at least one cash letter received from the at least one sending institution. Then, the computerized host system provides images of cash items in the at least one cash letter to the at least one receiving institution.

Other variations and embodiments of the present invention will become apparent to those skilled in the art when the following description is reviewed with the aide of the attached drawings and appended claims.

### BRIEF DESCRIPTION OF THE SEVERAL VIEWS OF THE DRAWING

FIG. 1 is a schematic diagram of a system for direct presentment of cash letters to financial institutions in accordance with the present invention.

FIG. 2 is a logic flow diagram illustrating an exemplary manner of utilizing the system depicted in FIG. 1.

### DETAILED DESCRIPTION OF THE INVENTION

Presently preferred embodiments of the invention are shown in the above-identified figures and described in detail below. In describing the preferred embodiments, like or identical reference numerals are used to identify common or similar elements. The figures are not necessarily to scale and certain features and certain views of the figures may be shown exaggerated in scale or in schematic in the interest of clarity and conciseness.

Definitions

Certain terms are defined throughout this description as they are used, while certain other terms used in this description are defined below.

The term “computer system” and/or “computer” and/or “program logic systems” as used herein means a system(s) that is able to embody and/or execute the logic of the processes described herein. The logic embodied in the form of software instructions or firmware may be executed on any appropriate hardware which may be a dedicated system or systems, or a general-purpose computer system, a personal computer system, a distributed processing system, all of which are well understood in the art and a detailed description of how to make or use such computers is not deemed necessary herein.

The term “communication link” refers to any suitable device or communication system permitting electronic communications and/or optical communications. Examples of such communication systems include internal buses, local area networks, wide area networks, point-to-point shared and dedicated communications, infrared links, microwave links, telephone links, cable TV links, satellite links, radio links, and fiber-optic links. Further, other examples of communication systems include the Internet. The term “communication link” can also refer to any suitable communication system for sending data and/or messages between remote locations, directly or via a third-party communication provider such as AT&T. It should be understood that each of the communication links are shown and described separately herein for the sole purpose of clearly illustrating the information being communicated. In an actual implementation, the communication links may not be separate communication links but may be a single communication link.

Institution

“Institution” refers to a party, such as a financial institution involved in either the sending or the receiving of one or more cash letter files as described below. Exemplary financial institutions include banks, credit unions, saving and loans and the like. Each institution is provided with a computer system (Institution computer). Single or multiple computer systems may act as the Institution computer.

Sending Institution

“Sending institution” refers to an institution which has uploaded a settlement request including a cash letter to a host system.

Receiving Institution

“Receiving institution” refers to an institution which has downloaded a settlement request including the cash letter from the host system.

Cash Letter

“Cash Letter” is an inter-institution, or intra-institution transmittal letter that accompanies cash items sent from one institution or department to another.

### DETAILED DESCRIPTION

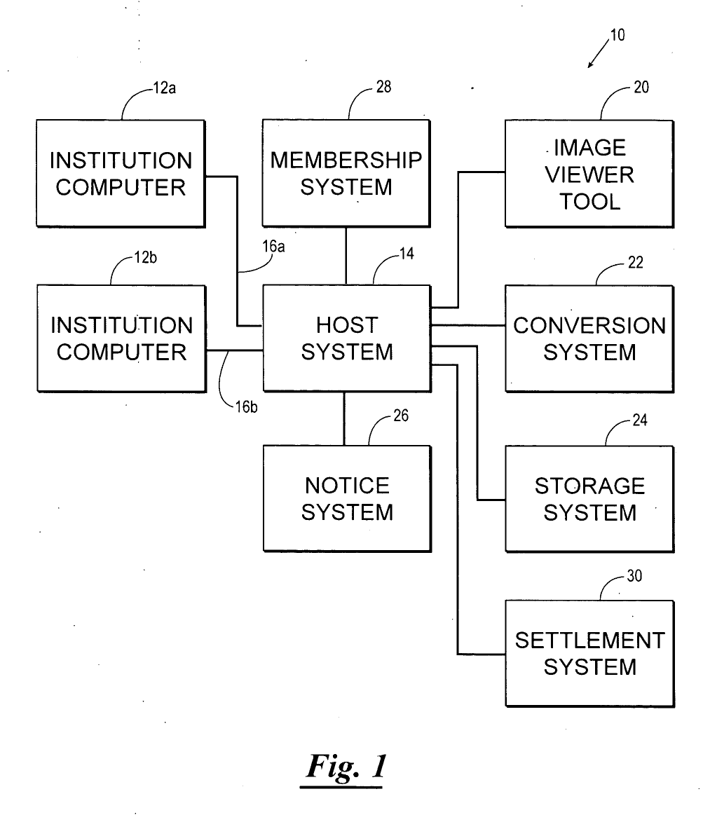

Referring now to the drawings, and in particular to FIG. 1, shown therein is a system 10 for direct presentment of cash letters to financial institutions in accordance with the present invention. The system 10 includes a plurality of institution computers 12 (designated for purposes of clarity by the reference numerals 12a and 12b) communicating with a host system 14 via communication links 16a and 16b. Preferably, (1) the host system 14 is implemented as a secure web-site that enables financial institutions to exchange image files of cash letters and cash items, and to settle directly with each other just like the financial institutions were doing direct presentment with the physical items, (2) the institution computers 12 are implemented as personal computers loaded with web browsers, and (3) the communication links 16a and 16b are implemented as the “Internet.”

In general, the host system 14 is provided with an image viewer tool 20, a conversion system 22, a storage system 24, a notice system 26, a membership system 28, and a settlement system 30. The image viewer tool 20 of the host system 14 permits a user or operator of the host system 14 to browse the image files to verify the MICR data against the hand-written or computer-printed data on a check, such as the amount, date, etc. The conversion system 22 converts the image files into a predetermined or pre-selected format, such as X9.37 or Common Object File Format (“COFF”), if they are not already. The predetermined or pre-selected format can be determined by the operator of the host system 14 or by each institution that will be reading the images files. The conversion system 22 also reads COFF (Old Fed image format) format files, X9.37 formats as well as custom formats. The conversion system 22 is also able to verify that a file is in the correct format and that the amounts agree to the total. The conversion system 22 is also able to perform some image quality analysis to insure the quality of the images that are being exchanged. The storage system 24 is utilized to store the image cash letters while waiting for them to be received by one of the institution computers 12 of a receiving institution. It should be noted that the system 10 is Check 21 compliant and follows the ECCHO (Electronic Check Clearing House Organization) standards and the Federal Reserve standards.

The notice system 26 is used to provide notices to the institutions involved in the presentment service. For example, a notice can be provided to the sending institution that loads a settlement request to the host system 14, or to the receiving institution in which the settlement request can be passed. In a preferred embodiment, the notices will be provided as e-mail messages transmitted to the institution computers 12. However, it should be understood that other forms of notices can be used such as telephone calls, facsimiles, text messages or the like.

The settlement system 30 is available to the institutions that do not wish to separate their images of cash items by institution to create a separate file and cash letter for each institution. If an institution opts to use the settlement system 30 of the host system 14 then that institution can upload a single file containing a single cash letter having a plurality of images of cash items which have not been separated by institution. The settlement system 30 can be a function performed by the host system 14 or it can be performed by a third party settlement agency to aggregate settlement between institutions selected by the operators of the host system 14. Whether the settlement system 30 is used will be determined by the membership options selected by each institution. In an alternative embodiment, an agreement can be reached with a specific institution prior to being eligible to use the settlement system 30. If an agreement is reached between the host system 14 and a specific institution, the settlement system 30 can also notify each financial institution of the amounts owed for each cash letter sent and received.

The host system 14 desirably functions as a fee-based, members only presentment service where the membership system 28 is utilized to verify that each institution which is a party to a settlement is valid or current before the presentment service is provided. Although the host system 14 and institution computers 12 are described by way of example for use by financial institutions, e.g., banks, it should be understood that the present invention can be used by other types of institutions, such as universities, or for intercompany transactions. In the system 10, the institutions are desirably responsible for separating their cash items by institution and for creating a separate file for each institution. Then, the multiple files are uploaded to the host system 14, as will be described in more detail below.

In one preferred embodiment, the following information is provided to the membership system 28 of the host system 14 to register the institution with the host system 14.
1. Financial Institution name
2. Financial Institution Routing number
3. Contact name
4. Contact phone number
5. Contact email address
6. Financial Institution shipping address
7. Financial Institution mailing address
8. Admin—User name and Password—used for changing Financial Institution information
9. User name and Password—used to upload and download files
10. Returns user name and Password—used for creating return files and printing IRDs
11. Security Question for password reset—needed for each user Id
12. Email address for notification of files that have been uploaded for processing
13. Email address for notification of files that have been downloaded for processing
14. Email address for notification of settlement—sent when files from both Financial Institutions have been uploaded to the site.
15. IP address of one or more institution computer 12.

A periodic membership fee, a transaction charge and combinations thereof may be charged by the operator of the host system 14 for the presentment service.

The foregoing information can be input into the membership system 28 of the host system 14 via any suitable manner. For example, the membership system 28 is desirably configured to acquire its data from a variety of optional sources preferably chosen by the institution or user, such as verbally through a telephone customer service network, a mobile phone, email, or an interactive web site. Furthermore, users or the institution could mail the foregoing information to the host system 14 and an individual at the host system 14 could input the information into the membership system 28 via a keyboard or other similar input device. In one embodiment, the user inputs the selected information into the membership system 28 via the institution computer 12.

Once an institution is registered, the institution can pass settlement requests to the host system 14 for direct presentment of cash items to member institutions. For example, assuming that an institution has cash items to be drawn on banks a, b and c, the institution would transmit three separate settlement requests to the host system 14 utilizing the institution computer 12. Thus, a settlement request for one or more cash items to be drawn on bank a is passed, a settlement request for one or more cash items to be drawn on bank b is passed, and a settlement request for one or more cash items to be drawn on bank c is passed.

Each settlement request includes one or more image files from the institution with each of the image files represent a cash letter including images of cash items. In addition, the following information can be included in the settlement request to identify the institution that the cash items will be drawn against:
1. Financial Institution name;
2. Financial Institution routing;
3. Email address for notification of files that have been uploaded or downloaded for processing; and
4. Email for notification of settlement amount based on settlement method—sent when files from both Financial Institutions have been uploaded to the site.

Institutions involved in direct presentment of cash items are required to work out a settlement agreement between them selves. A sample agreement could be provided by the host system 14, but the institutions could make changes to the sample agreement, or could enter into their own agreement. The sample agreement could be interactive and designate specifics such as method of settlement and times to settle. This information could be provided to the institution computer 12 by the host system 14 and displayed on the screen of the institution computer 12.

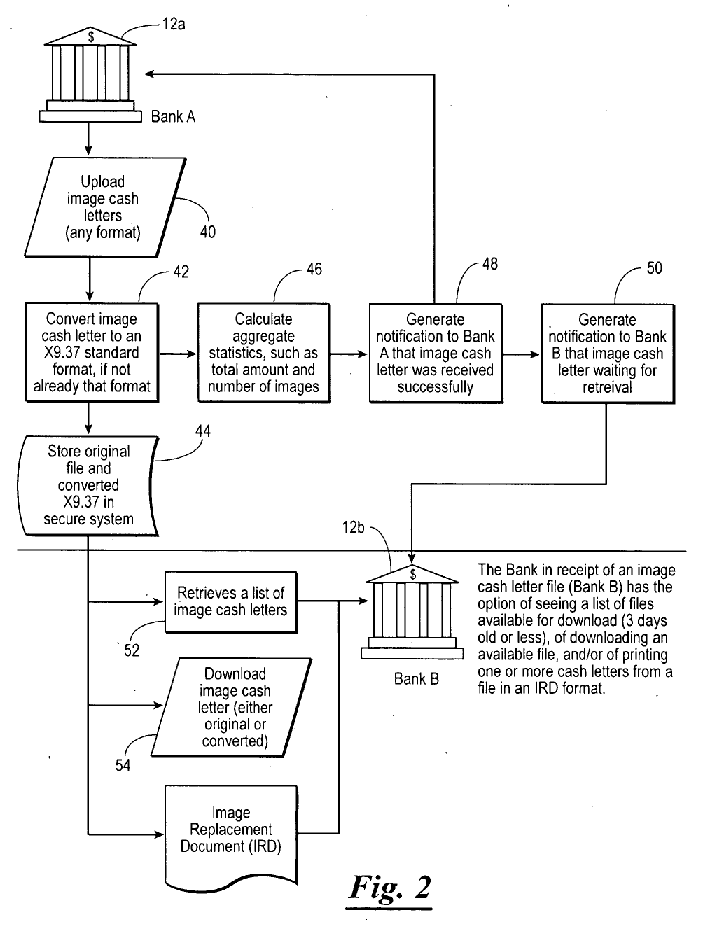

Referring now to FIG. 2, the operation of the host system 14 will now be described. The host system 14 maintains an introductory or welcome home page screen accessible to all users, such as internet users. Such screen or screens desirably provide information regarding the host system 14, administrative and advertising information, hypertext links to related Internet web sites and other information beneficial to the use and promotion of the system 10. Then, the software running on the host system 14 proceeds to determine the identity of a requesting institutional computer 12 (e.g. its user).

When the requesting institutional computer 12 requests access to the host system 14, the membership system 28 authenticates the validity of the requesting institutional computer 12 (e.g. its user) by using password protection and/or other security methods known in the art, such as encryption, SSL certificate, Secure sign-on or Virtual Private Network (VPN).

The host system 14 preferably includes a secure FTP site for uploading and downloading the image files. When an institution signs in via the institution computer 12, they receive a screen that shows them the image cash letters that have been received and are ready for them to download. In addition, the screen shows the institution that sent the image cash letter, the amount, # of images, date and time uploaded, and a list of the image cash letters the institution has uploaded that are waiting to be downloaded by the receiving Financial Institution. In one preferred embodiment, the screen would show all cash letters but gray-out the ones that have already been downloaded.

As an example, the institution computer 12a will be described as a sending institutional computer, meaning that the institution computer 12a will be uploading a settlement request including an image cash letter to the host system 14. The institution computer 12b will be described as a receiving institutional computer, meaning that the institution computer 12b will be receiving the settlement request and downloading the image cash letter from the host system 14.

In use, the institution computer 12a uploads a settlement request to the host system 14 as indicated by the reference numeral 40. Then, the conversion system 22 of the host system 14 converts the image cash letter to any suitable or desired format for further processing by the host system 14 as indicated by a block 42. The original image cash letter and the converted cash letter is then stored on the storage system 24 as indicated by a reference numeral 44. The host system 14 then calculates aggregate statistics, such as total amount and number of images as indicated by a reference numeral 46 and verifies this against the totals that were input by Bank A when they uploaded the file. The host system 14 also verifies the image quality of the check images. This can be accomplished by an operator utilizing the image viewer tool 20 or can be conducted automatically by software.

Then, a notice, such as an email is sent to both the sending and receiving institutions as indicated by the reference numerals 48 and 50. The notice to the sending and receiving institutions includes the time when a file has been uploaded for processing and giving the name of the sending institution that uploaded the file, the name of the receiving institution that the file is going to, the total amount and # of images.

The receiving institution then logs onto the host system 14 using the institution computer 12b and receives a list of settlement requests including a list of image cash letters for settlement by the receiving institution as indicated by a reference numeral 52. Then, the receiving institution downloads the converted file including the image cash letter and cash items using the institution computer 12b as indicated by a reference numeral 54.

The host 14 passes another notice to the sending and receiving institutions when a file has been downloaded for processing. The notice typically includes the name of the institution that downloaded the file, the name of the institution that the file is going to, the total amount and # of images. A notice, such as an email showing the amount of the wire that each Financial Institution will send to the other for the settlement total of the items deposited is then sent to the sending and receiving institutions. The receiving institution then settles the cash items in a manner known in the art, such as by wiring the monies to the sending institution desirably using an interfinancial institution wiring system outside of the host system 14.

Alternatively, the host system 10 can facilitate the settling of the monies between the institutions on a daily basis. The host system 14 will have to calculate the difference between at least two uploads and send a notice telling the institutions that they must either wire the difference (net settlement) to the other Financial Institution or they will receive a wire for the difference from the other Financial Institution. For example, assume that institutions a and b are both sending and receiving institutions in a same day. On this day, institution a owes $1,000,000 in cash items to institution b, and institution b owes $1,100,000 in cash items to institution a. The host system 14 can calculate the amount owed by each of the institutions, and send out a notice to institution a and institution b specifying that institution b wire the difference, i.e., $100,000 to institution a.

The image files included in the settlement requests can be stored for a fixed period of time, such as 3 business days. Thereafter, the image files would be automatically purged or deleted.

As an optional feature, the host system 14 can track or monitor the settlement time, i.e., the amount of time it takes to settle a cash letter once the settlement request is uploaded to the host system 14. This particular statistic is a management metric to show bank managers how efficient they are at downloading cash letters waiting for them. For example, if an employee missed a download and settlement of a $1,000,000 direct presentment cash letter, then they missed out on a day of interest on that million dollars, and the bank that uploaded the letter gets to count that float because the other bank is inefficient. Additionally, the host system 14 can be notified of an agreed upon time for financial institutions to settle cast letters. If that agreed upon time arrives and the cash letters have not been settled, the host system 14 can notify the financial institution that has not performed their portion of the settlement.

In an exemplary embodiment, the host system can include a return item feature. The return item feature allows a receiving institution to flag a bad cash item and electronically return it to the sending institution. For example, institution a uploads a cash item to the host system and institution b downloads the cash item and discovers that it is a bad cash item, such as a check having insufficient funds. Institution b can then flag the cash item and send the bad cash item electronically, via the host system 14, back to institution a.

Image Replacement Documents (“IRD”) are a commonly-accepted format for recreating a physical copy of a check from an image that is as legally acceptable as the original image itself. The host system 14 can be adapted to provide the institutions with a method to print IRDs from the host system 14 for those returns that they need to give back to the customer. Institutions could pull the physical check if they choose or they could simply print an IRD on a laser printer with a MICR toner cartridge. This will prevent them from having to purchase an expensive program to print IRDs from their current image vendor.

It will be understood from the foregoing description that various modifications and changes may be made in the preferred and alternative embodiments of the present invention without departing from its true spirit.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

1. A computerized system for the direct presentment of cash letters having images of cash items from a sending institution computer to a receiving institution computer, comprising:
a computerized host system having a web-server communicating with at least one sending institution computer, the computerized host system receiving from the at least one sending institution computer at least one cash letter, the computerized host system storing the at least one cash letter, and providing images of cash items in the at least one cash letter to at least one receiving institution.

2. The system of claim 1, wherein the sending institution computer has a web browser.

3. The system of claim 1, wherein the computerized host system receives a plurality of cash letters from a sending institution computer, each cash letter including only images of cash items corresponding to a different individual receiving institution.

4. The system of claim 1, wherein the computerized host system further includes a settlement system receiving images of cash items from a single cash letter including images of cash items requiring settlement with multiple receiving institutions.

5. The system of claim 1, wherein the computerized host system further includes a notification system transmitting e-mails to the sending and receiving institution computers, notifying the at least one sending institution that their settlement request has been loaded, and notifying the receiving institution that a settlement request can be passed.

6. The system of claim 1, wherein the cash items are checks.

7. The system of claim 1, wherein the sending institutions and the receiving institutions are selected from the group consisting of banks, credit unions, and savings and loans.

8. The system of claim 1, wherein the computerized host system further comprises a membership system verifying membership of the sending and receiving institutions wherein the sending and receiving institutions are required to pay a fee to maintain the membership to access the computerized host system.

9. The system of claim 1, wherein the computerized host system further includes a conversion system converting the images of cash items into a predetermined format.

10. The system of claim 1, wherein the computerized host system further includes an image viewer tool permitting an operator of the computerized host system to verify the magnetic ink characters (MICR) against the hand-written or computer-printed data on the cash item.

11. A method of using a computerized host system for the direct presentment of cash letters having images of cash items from a sending institution computer to a receiving institution computer, comprising the steps of:
communicating with at least one sending institution computer via a web-server;
receiving at least one cash letter from the at least one sending institution;
storing the at least one cash letter received from the at least one sending institution; and
providing images of cash items in the at least one cash letter to the at least one receiving institution.

12. The method of claim 11, wherein the sending institution computer has a web browser.

13. The method of claim 11, wherein the computerized host system receives a plurality of cash letters from a sending institution computer, each cash letter including only images of cash items corresponding to a different individual receiving institution.

14. The method of claim 11, wherein the computerized host system further includes a settlement system receiving images of cash items from a single cash letter including images of cash items requiring settlement with multiple receiving institutions.

15. The method of claim 11, wherein the computerized host system further includes a notification system transmitting e-mails to the sending and receiving institution computers, notifying the at least one sending institution that their settlement request has been loaded, and notifying the receiving institution that a settlement request can be passed.

16. The method of claim 11, wherein the cash items are checks.

17. The method of claim 11, wherein the sending institutions and the receiving institutions are selected from the group consisting of banks, credit unions, and savings and loans.

18. The method of claim 11, wherein the computerized host system further comprises a membership system verifying membership of the sending and receiving institutions wherein the sending and receiving institutions are required to pay a fee to maintain the membership to access the computerized host system.

19. The method of claim 11, wherein the computerized host system further includes a conversion system converting the images of cash items into a predetermined format.

20. The method of claim 11, wherein the computerized host system further includes an image viewer tool permitting an operator of the computerized host system to verify the magnetic ink characters (MICR) against the hand-written or computer-printed data on the cash item.
